(19) United States
(12) Patent Application Publication
(10) Pub. No.: US 2008/0122964 A1
(43) Pub. Date: May 29, 2008

(54) Solid-state imaging device and driving method thereof

(76) Inventor: Nobukazu TERANISHI, Tokyo (JP)

Correspondence Address: MCDERMOTT WILL & EMERY LLP, 600 13TH STREET, NW, WASHINGTON, DC, 20005-3096, US

(21) Appl. No.: 11/976,664

(22) Filed: Oct. 26, 2007

(30) Foreign Application Priority Data
Nov. 28, 2006 (JP) 2006-320424

(51) Int. Cl. H04N 5/335

(52) U.S. Cl. 348/312; 348/E05.091; 348/E05.092

(57) ABSTRACT

A solid-state imaging device and a driving method thereof which are capable of reducing power consumption required for reading an image are provided. A horizontal transfer section 19 is constituted of a block A including a plurality of transfer electrodes 20a aligned in rows, and a block B including a plurality of transfer electrodes 20b aligned in columns. In the case where the horizontal transfer section 19 is a two-phase drive CCD, wirings 21a and 22a to supply driving pulses φH1A and φH2A are connected to the block A, and wirings 21b and 22b to supply driving pulses φH1B and H2B are connected to the block B. While the solid-state imaging device 1 is being driven, after completion of transfer of electric charges from the block B to the block A, supply of the driving pulses φH1B and φH2B to the block B is stopped.

### BACKGROUND OF THE INVENTION

1. Field of the Invention

The present invention relates to a solid-state imaging device and a driving method thereof. More specifically, the present invention relates to a solid-state imaging device having a CCD (charge coupled device) and a driving method thereof.

2. Description of the Background Art

A CCD and a CMOS are each known as an exemplary type of a solid-state imaging device. Generally, a CCD solid-state imaging device is highly sensitive and has a low dark output compared to a CMOS solid-state imaging device, and thus the CCD solid-state imaging device is introduced to various imaging devices. In terms of an array of a plurality of pixels, the CCD solid-state imaging device can be divided into two types, i.e., an area sensor which is embedded in a digital video camera or a digital still camera and a linear sensor which is embedded in an image scanner or a copy machine. Hereinafter, the solid-state imaging device having these two types will be described briefly.

FIG. 13 is a diagram showing a general configuration of a conventional area solid-state imaging device. FIG. 13 shows only a part of the solid-state imaging device for convenience of illustration.

The solid-state imaging device 91 includes a plurality of photoelectric conversion sections 16 which are arranged two-dimensionally, a plurality of vertical transfer sections 17 which are each provided to a column of the photoelectric conversion sections 16 and transfers electric charges outputted respectively from the column of the photoelectric conversion sections 16 in a vertical direction, a horizontal transfer section 95 for transferring the electric charges outputted from each of the plurality of vertical transfer sections 17 in a horizontal direction, and an electric charge detection section 23 for detecting the electric charges outputted from the horizontal transfer section 95.

Each of the vertical transfer sections 17 is a CCD including a plurality of transfer electrodes 18 which are arranged so as to be aligned in columns. In the case where each of the vertical transfer sections 17 is a four-phase CCD, four-phase driving pulses φV1 to φV4 are supplied to four of the transfer electrodes 18 which are successively aligned.

The horizontal transfer section 95 is a CCD including a plurality of transfer electrode 96 which are arranged so as to be aligned in rows. In the case where the horizontal transfer section 95 is a two-phase CCD, two-phase driving pulses φH1 and φH2 are supplied so as to drive the horizontal transfer section. More specifically, the transfer electrodes 96 included in the horizontal transfer section 95 are alternately connected, in pairs, to a wiring 97 and a wiring 98, and provided with the driving pulses φH1 and φH2 through driving pulse supply points provided to the wiring 97 and the wiring 98.

The electric charge detection section 23 includes a floating diffusion (FD) for temporarily accumulating the electric charges, an output gate OG for transferring the electric charges from the horizontal transfer section 95 to the FD, an amplifier circuit 24 for outputting a signal corresponding to a potential difference of the FD, a reset gate (RG) for resetting the FD, and a reset drain (RD).

FIG. 14 is a timing chart showing a driving method of the solid-state imaging device shown in FIG. 13. FIG. 14 shows only the driving pulses φH1 and φH2 which are supplied to the horizontal transfer section 95 shown in FIG. 13.

During a horizontal blanking time period, electric charges of one row are outputted from the respective vertical transfer sections 17 to the horizontal transfer section 95, and the electric charges of the one row held in the horizontal transfer section 95 are then transferred toward the electric charge detection section 23 in sequence, in units of pixels, in accordance with the driving pulses φH1 and φH2. The electric charge detection section 23 outputs, from an output terminal OUT, a pixel signal which corresponds to the electric charges outputted from the horizontal transfer section 95.

FIG. 15 is a diagram showing a general configuration of a conventional linear solid-state imaging device. FIG. 15 shows only a part of the solid-state imaging device for convenience of illustration.

The solid-state imaging device 92 includes a plurality of photoelectric conversion sections 16 arranged one-dimensionally, an electric charge transfer section 98 for transferring electric charges outputted from each of the plurality of photoelectric conversion sections 16, and an electric charge detection section 23 for detecting the electric charges outputted from the electric charge transfer section 98.

The electric charge transfer section 98 is a CCD basically having the same configuration as the horizontal transfer section 95 shown in FIG. 13. In the case where the electric charge transfer section 98 is a two-phase CCD, in order to supply driving pulses φ1 and φ2 to the electric charge transfer section 98, transfer electrodes 99 adjoining each other are connected, in pairs, to a wiring 97 and a wiring 98, alternately. To each of the transfer electrodes 99, either of the driving pulses φ1 and φ2 is supplied through the driving pulse supply points which are provided to the wiring 97 and the wiring 98.

FIG. 16 is a timing chart showing a driving method of the solid-state imaging device shown in FIG. 15.

As shown in FIG. 16, the electric charges outputted from the photoelectric conversion sections 16 to the electric charge transfer section 98 are transferred to the electric charge detection section 23 in sequence, in units of pixels, in accordance with the driving pulses φ1 and φ2. The electric charge detection section 23 outputs, from the output terminal OUT, a pixel signal corresponding to the electric charges outputted from the electric charge transfer section 98.

Japanese Laid-Open Patent Publication No. 62-219573, for example, is known as prior art relating to the present invention.

In recent years, the solid-state imaging device is required to have high resolution and to perform a high-speed operation. For example, the number of pixels of a digital camera is steadily increasing. In accordance with the increase in the number of the pixels, a speed for reading an image from the solid-state imaging device is also required to be increased. A CCD sensor for taking moving images is also required to perform a high-speed operation in the wake of introduction of HDTV. A one-dimensional CCD sensor, which is embedded in an image scanner, a copy machine or the like, is also required to perform a high-speed operation.

However, when the increase in the number of the pixels and the increase in the speed for reading are to be realized, a problem will be caused in that power consumption of the solid-state imaging device also increases. A small size battery is used for a portable imaging device such as a digital camera or the like, particularly, in order to reduce a device size thereof. However, it is not desirable that time for continuously using an imaging device is shortened due to a reduction in a battery size. Therefore, in addition to the high resolution and the high-speed operation, the solid-state imaging device is required to achieve a reduction in the power consumption as much as possible.

### SUMMARY OF THE INVENTION

Therefore, an object of the present invention is to provide a solid-state imaging device and a driving method thereof which allow reduction in power consumption necessary to read an image.

A first aspect is directed to a driving method of a solid-state imaging device including a plurality of photoelectric conversion sections which are arranged two-dimensionally, a plurality of vertical transfer sections provided for respective columns of the plurality of photoelectric conversion sections, a horizontal transfer section including a plurality of blocks each individually receiving supply of a driving pulse, and an electric charge detection section for detecting electric charges. The driving method outputs the electric charges accumulated in each of the plurality of photoelectric conversion sections to each of the plurality of vertical transfer sections; transfers the electric charges held in said each of the plurality of vertical transfer sections to the horizontal transfer section in sequence; transfers, in sequence, the electric charges held in the horizontal transfer section to the electric charge detection section by supplying the driving pulse individually to each of the plurality of blocks; and stops supply of the driving pulse to a block, among the plurality of blocks, having no electric charge.

A second aspect is directed to a driving method of a solid-state imaging device including a plurality of photoelectric conversion sections arranged one-dimensionally, a horizontal transfer section including a plurality of blocks each individually receiving supply of a driving pulse, and an electric charge detection section for detecting electric charges. The driving method outputs the electric charges accumulated in each of the plurality of photoelectric conversion sections to the electric charge transfer section; transfers the electric charges held in the electric charge transfer section to the electric charge detection section, in sequence, by supplying the driving pulse individually to each of the plurality of blocks; and stops supply of the driving pulse to a block, among the plurality of blocks, having no electric charge.

In each of the above-described driving methods, in the case where the solid-state imaging device further includes a switch transistor electrically connected to said each of the plurality of blocks, the supply of the driving pulse and a cessation of the supply of the driving pulse may be performed by switching on and off the switch transistor.

A third aspect is directed to a solid-state imaging device. The solid-state imaging device comprises: a plurality of photoelectric conversion sections arranged two-dimensionally; vertical transfer sections which are provided for respective columns of the plurality of photoelectric conversion sections and transfer, in sequence, electric charges outputted by the plurality of the photoelectric conversion sections in a vertical direction; a horizontal transfer section which includes N blocks (N is a natural number of 2 or more) each having a plurality of transfer electrodes and transfers, in sequence, the electric charges outputted by each of the vertical transfer sections in a horizontal direction; a plurality of wirings which are each provided for said each of the N blocks and connected to a driving pulse supply point for supplying a driving pulse and to each of the plurality of transfer electrodes included in said each of the N blocks; and an electric charge detection section for detecting the electric charges outputted by the horizontal transfer section. A product between a resistance and a capacity of a part of each of the plurality of wirings is approximately equal between the plurality of wirings, the part of each of the plurality of wirings being from one of a pair of the plurality of transfer electrodes, which are situated across a boundary between two adjoining blocks of the N blocks, to a driving pulse supply point connected to said one of the pair of the plurality of transfer electrodes.

A fourth aspect is directed to a solid-state imaging device. The solid-state imaging device comprises: a plurality of photoelectric conversion sections arranged one-dimensionally; an electric charge transfer section which includes N blocks (N is a natural number of 2 or more) each having a plurality of transfer electrodes and transfers, in sequence, electric charges outputted by each of the plurality of photoelectric conversion sections; a plurality of wirings which are provided for each of the N blocks and connected to a driving pulse supply point for supplying a driving pulse and to each of the plurality of transfer electrodes included in each of the N blocks; and an electric charge detection section for detecting the electric charges outputted by the horizontal transfer section. A product between a resistance and a capacity of a part of each of the plurality of wirings is approximately equal between the plurality of wirings, the part of each of the plurality of wirings being from one of a pair of the plurality of transfer electrodes, which are situated across a boundary between two adjoining blocks of the N blocks, to a driving pulse supply point connected to said one of the pair of the plurality of transfer electrodes.

In each of the above-described solid-state imaging devices, a distance from the boundary between the two adjoining blocks to the driving pulse supply point may be set so as to be approximately identical between the adjoining two blocks.

Further, a switch transistor connected to the driving pulse supply point may be included.

Further, it is desirable that a length of each of the N blocks is approximately equal to each other.

According to the solid-state imaging device and the driving method thereof according to the present invention, the supply of the driving pulse and the cessation of the supply of the driving pulse can be controlled in units of blocks included in the horizontal transfer section (electric charge transfer section). Accordingly, the power consumption of the horizontal transfer section (electric charge transfer section) can be reduced by stopping the driving of the block which has completed transfer of the electric charges.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a general configuration of an imaging system including a solid-state imaging device according to respective embodiments of the present invention;

FIG. 2 is a diagram showing a general configuration of a solid-state imaging device according to a first embodiment of the present invention;

FIG. 3 is a timing chart showing a driving method of the solid-state imaging device shown in FIG. 2;

FIG. 4 is a diagram showing a general configuration of a solid-state imaging device according to a second embodiment of the present invention;

FIG. 5 is a timing chart showing a driving method of the solid-state imaging device shown in FIG. 4;

FIG. 6 is a diagram showing a general configuration of a solid-state imaging device according to a third embodiment of the present invention;

FIG. 7A is a diagram showing a waveform of a driving pulse at a driving pulse supply point;

FIG. 7B is a diagram showing a waveform of a driving pulse at a point away from the driving pulse supply point;

FIG. 8 is a diagram showing a general configuration of a solid-state imaging device according to a fourth embodiment of the present invention;

FIG. 9 is a diagram showing a general configuration of a solid-state imaging device according to a fifth embodiment of the present invention;

FIG. 10 is a diagram showing a general configuration of a solid-state imaging device according to a sixth embodiment of the present invention;

FIG. 11A is a diagram showing an exemplary switch circuit used for a solid-state imaging device according to a seventh embodiment of the present invention;

FIG. 11B is a diagram showing another exemplary switch circuit used for the solid-state imaging device according to the seventh embodiment of the present invention;

FIG. 12 is a diagram showing a driving method of the solid-state imaging device according to the seventh embodiment of the present invention;

FIG. 13 is a diagram showing a general configuration of a conventional area solid-state imaging device;

FIG. 14 is a timing chart showing a driving method of the solid-state imaging device shown in FIG. 13;

FIG. 15 is a diagram showing a general configuration of a conventional linear solid-state imaging device; and

FIG. 16 is a timing chart showing a driving method of the solid-state imaging device shown in FIG. 15.

### DESCRIPTION OF THE PREFERRED EMBODIMENTS

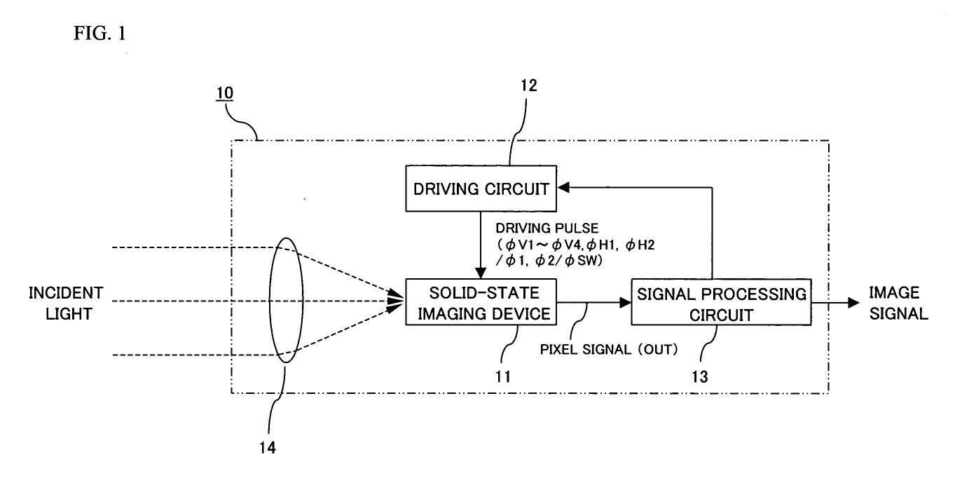

FIG. 1 is a block diagram showing a general configuration of an imaging system including any one of solid-state imaging devices according to respective embodiments of the present invention.

The imaging system 10 shown in FIG. 1 includes, as major component parts, an optical system 14 such as a lens, an optical filter and the like, a solid-state imaging device 11 for outputting a pixel signal corresponding to light incident through the optical system 14, a driving circuit 12 for outputting a driving pulse so as to drive the solid-state imaging device 11, and a signal processing circuit 13 for performing various image processes with respect to the pixel signal outputted from the solid-state imaging device 11 and outputting an image signal having been processed.

The imaging system 10 may be a digital still camera or a digital video camera, for example. Alternatively, the imaging system 10 maybe a reading unit of an image scanner or a copy machine. As the solid-state imaging device 11, a solid-state imaging device having either of a two-dimensional pixel area or one-dimensional pixel area may be used, among the solid-state imaging devices according to the respective embodiments described later, based on a type of the imaging system 10. The driving circuit 12 supplies the driving pulse necessary to drive the solid-state imaging device 11 in accordance with a form and a driving method of the pixel area.

Hereinafter, with reference to drawings, the solid-state imaging device and the driving method thereof according to each of the respective embodiments, from a first to a seventh embodiment, will be described.

### First Embodiment

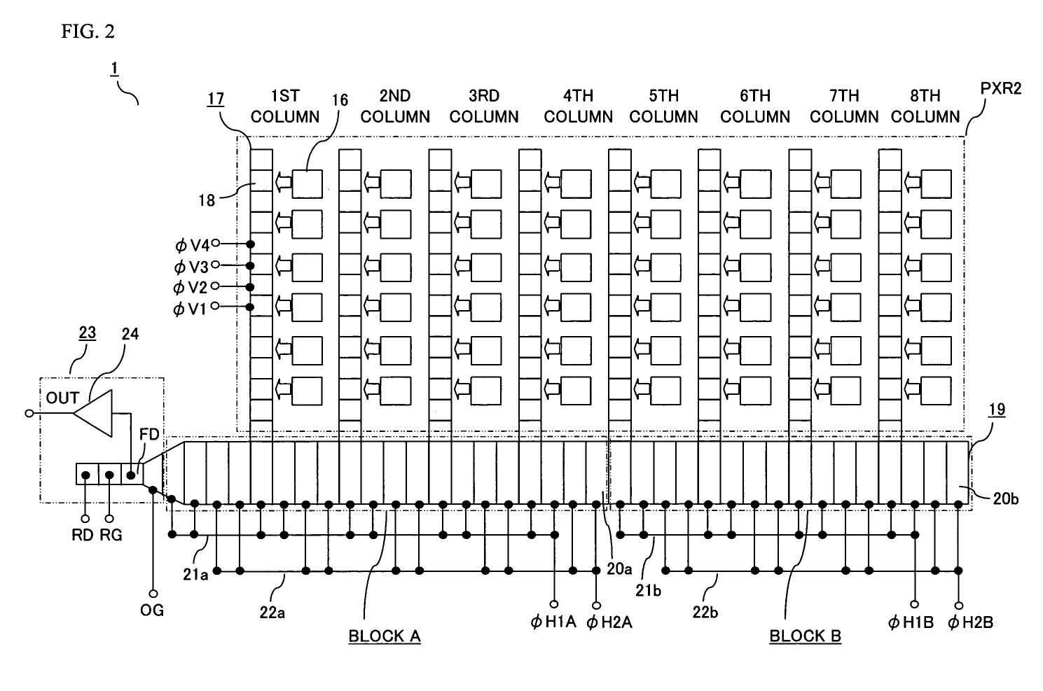

FIG. 2 is a diagram showing a general configuration of the solid-state imaging device according to the first embodiment of the present invention.

A solid-state imaging device 1 according to the present embodiment has a two-dimensional pixel area PXR 2, and used for the digital cameral, for example. The solid-state imaging device 1 is arranged two-dimensionally in a row direction and a column direction, and includes a plurality of photoelectric conversion sections 16 each for accumulating an electric charge corresponding to intensity of incident light, a plurality of vertical transfer sections 17 each provided to a column of the photoelectric conversion sections 16, a horizontal transfer section 19, wirings 21a, 21b, 22a and 22b which are connected to the horizontal transfer section 19, and an electric charge detection section 23.

Although FIG. 2 typically shows the pixel area PXR 2 constituted of the photoelectric conversion section 16 arranged in a matrix of 6 rows by 8 columns and a part of component parts corresponding thereto, there may be a case where the numbers of the rows and the columns of the photoelectric conversion section included in the pixel area will be each thousand or more depending on an intended use of the solid-state imaging device 1.

Each of the vertical transfer sections 17 includes a plurality of transfer electrodes 18 which are aligned in columns, and transfers electric charges outputted from the column of the photoelectric conversion sections 16 sequentially in a vertical direction (column direction) in accordance with the driving pulse which is supplied from the driving circuit (see FIG. 1) to the plurality of transfer electrodes 18. For example, in the case where each of the vertical transfer sections 17 is a four-phase drive CCD, four-phase driving pulses φV1 to φV4 are supplied to respective sets of four transfer electrodes 18 which are successively aligned in the column direction.

The horizontal transfer section 19 is constituted of a block A including a plurality of transfer electrodes 20a which are aligned in the row direction and a block B including a plurality of transfer electrodes 20b which are aligned in the row direction. In each of the block A and the block B, wirings to supply the driving pulses are provided individually, and each of the block A and the block B transfers the electric charges, in sequence, in a horizontal direction (row direction) in accordance with the driving pulses supplied from the driving circuit (see FIG. 1).

In the case where the horizontal transfer section 19 is a two-phase drive CCD, the wiring 21a to supply the driving pulse φH1A and the wiring 22a to supply the driving pulse φH2A are connected to the block A. The transfer electrodes 20a adjoining each other are connected, in pairs, to the wiring 21a and the wiring 22a alternately. In a similar manner, the transfer electrodes 20b of the block B is connected, in pairs, to the wiring 21b and the wiring 22b.

The electric charge detection section 23 includes a floating diffusion (FD) for temporarily accumulating the electric charges, an output gate OG for transferring the electric charges from the horizontal transfer section 95 to the FD, an amplifier circuit 24 for outputting a signal corresponding to a potential difference of the FD, a reset gate (RG) for resetting the FD, and a reset drain (RD).

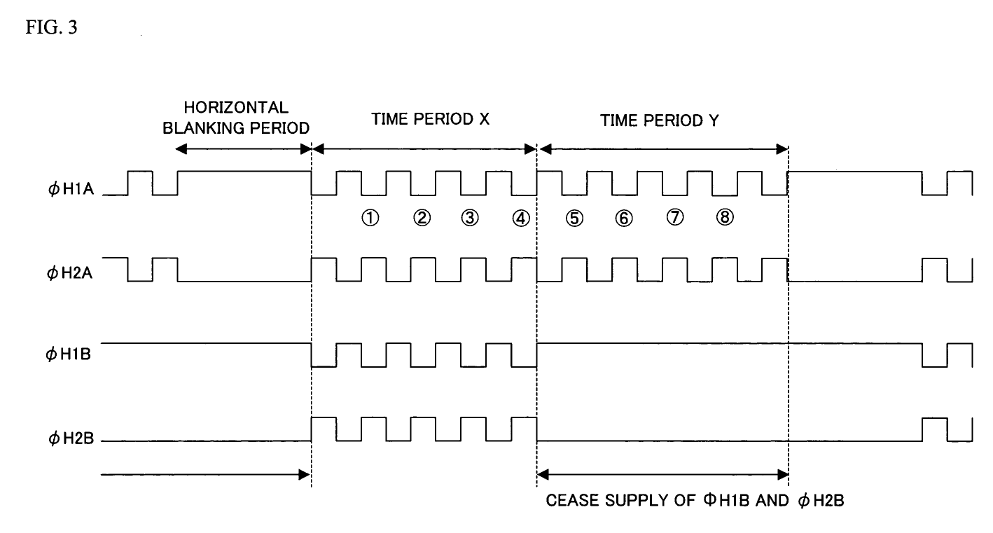

FIG. 3 is a timing chart showing a driving method of the solid-state imaging device shown in FIG. 2. Hereinafter, with reference to FIG. 3, in addition to FIG. 2, the driving method of the solid-state imaging device 1 according to the present embodiment will be described.

First, based on an imaging instruction (not shown) inputted to an imaging system, electric charges corresponding to the intensity of the incident light is accumulated in the respective photoelectric conversion sections 16, and the accumulated electric charges are outputted to each of the vertical transfer sections 17.

Predetermined driving pulses φV1 to φV4 are supplied during a horizontal blanking time period, whereby the electric charges, which are held in each of the vertical transfer sections 17, are transferred in the vertical direction, in units of rows. As a result, the electric charges outputted from one row of the photoelectric conversion sections 16 is held in the horizontal transfer section 19.

In a time period X, driving pulses φH1A and φH2A shown in FIG. 3 are supplied to the transfer electrodes 20a of the block A via the wiring 21a and the wiring 22a, respectively, and driving pulses φH1B and φH2B are supplied to the transfer electrodes 20b of the block B via the wiring 21b and the wiring 22b. The driving pulses having a common waveform are supplied to both of the block A and the block B, whereby the electric charges held in the horizontal transfer section 19 are transferred in sequence, in units of pixels, in the horizontal direction.

As a result, at timings of circled numbers one to four as shown in FIG. 3, respective electric charges outputted from a first to a fourth columns of the vertical transfer sections 17 are sequentially outputted to the electric charge detection section 23. Further, at completion of the time period X, respective electric charges outputted from a fifth to an eighth columns of vertical transfer sections 17 are held in the block A.

During a time period Y, the driving pulses φH1A and φH2A are continuously supplied to the block A as shown in FIG. 3, whereas the driving pulses φH1B and φH2B are stopped being supplied to the block B as shown in FIG. 3. As above described, the electric charges outputted from the fifth to the eighth columns of the vertical transfer sections 17 are already held in the block A as a result of the transfer during the time period X. Therefore, even though, during the time period Y, only the block A is driven and the driving of the block B in which no electric charge exists is stopped, the electric charges outputted from the fifth column to the eighth column vertical transfer sections 17 are outputted to the electric charge detection section 23 in sequence, at timings of circled numbers five to eight shown in FIG. 3.

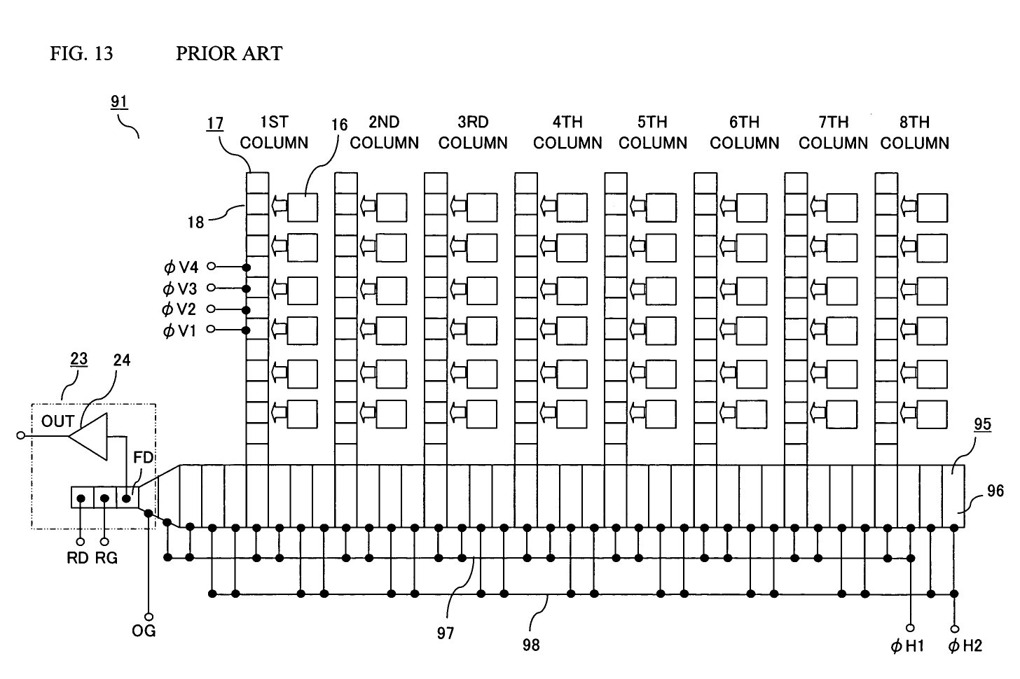

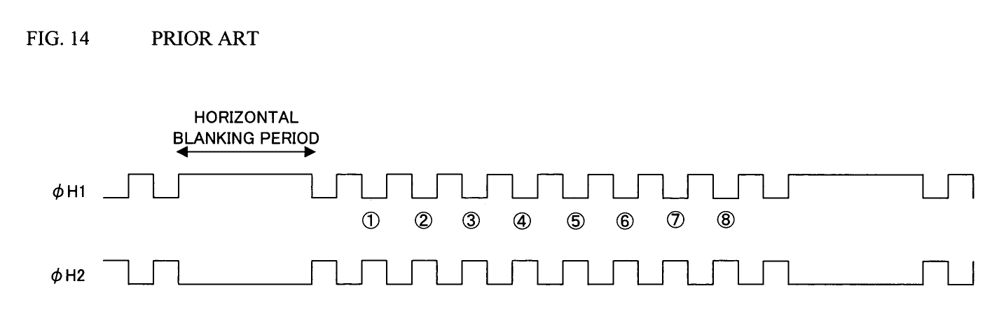

In a conventional driving method, as shown in FIGS. 13 and 14, until the transfer of the electric charges of one row is completed, the driving pulse is supplied to all the driving electrodes 96 in the horizontal transfer section 95.

On the other hand, in the driving method according to the present embodiment, the driving pulse is stopped to being supplied to the block B during the time period Y in which there exists no electric charge to be transferred to the block B, whereby it is possible to reduce electric power consumed by the horizontal transfer section 19. Specifically, in the case where the horizontal transfer section 19 is constituted of the block A and the block B whose length are approximately equal to each other, as with the case of the present embodiment, the power consumption of the horizontal transfer section 19 can be reduced by approximately 25%. Further, even in the case where the horizontal transfer section 19 is divided into two blocks, and the driving pulses are supplied to these two blocks individually, as with the case of the present embodiment, the electric charges of one column can be outputted uninterruptedly, in the same manner as the conventional driving method.

In the above-described example, a case is described where the horizontal transfer section 19 is drive-controlled in units of blocks which are constituted of two blocks, i.e., the block A and the block B, whose length are approximately equal to each other. However, the above-described driving method may be applicable to a case where the horizontal transfer section 19 is divided into three or more blocks whose lengths are approximately equal to one another, and then driven in units of blocks. Assuming that the horizontal transfer section 19 is divided into N blocks (N is a natural number of 2 or more) whose length are approximately equal to one another and then driven in units of blocks, it is possible to reduce the power consumption of the horizontal transfer section 19 by {(N+1)/2N} times as much as that of the case where horizontal transfer section 19 is not divided.

### Second Embodiment

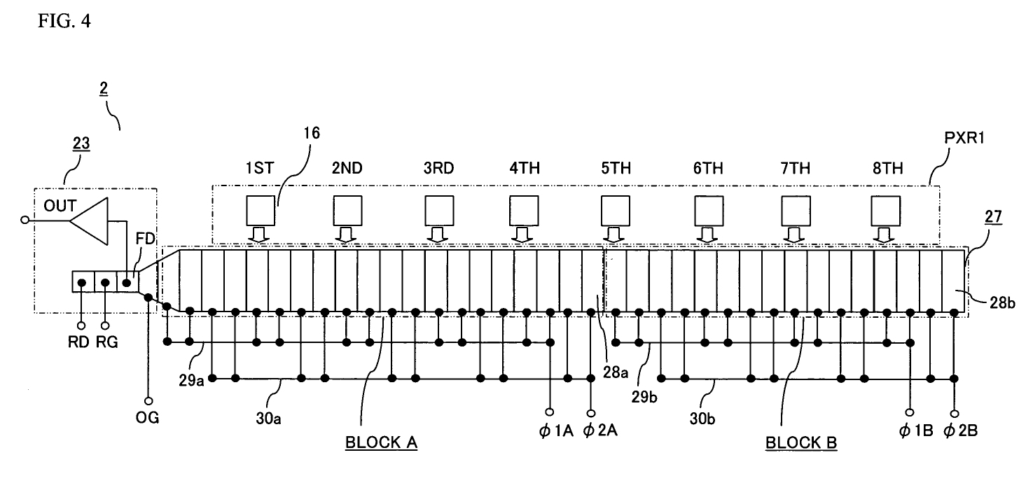

FIG. 4 is a diagram showing a general configuration of a solid-state imaging device according to a second embodiment of the present invention.

A solid-state imaging device 2 of the present embodiment has a one dimensional pixel area PXR1, and is used for an image scanner, a copy machine and the like, for example. The solid-state imaging device 2 includes a plurality of photoelectric conversion sections 16 arranged one-dimensionally, an electric charge transfer section 27, wirings 29a, 29b, 30a and 30b which are connected to the electric charge transfer section 27, and an electric charge detection section 23.

Although FIG. 4 typically shows eight photoelectric conversion sections and the electric charge transfer section 27 corresponding to a length of the eight photoelectric conversion sections, for convenience of illustration, there may be a case where the number of the photoelectric conversion sections 16 exceeds ten thousand depending on a type of a linear sensor.

The electric charge transfer section 27 is a CCD having the same configuration as the horizontal transfer section 19 according to the above-described first embodiment. That is, the electric charge transfer section 27 is constituted of a block A including a plurality of transfer electrodes 28a and a block B including a plurality of transfer electrodes 28b. In the case where the electric charge transfer section 27 employs a two-phase drive system, as with the case of the present embodiment, the transfer electrodes 28a which are included in the block A and adjoining each other are connected, in pairs, to the wiring 29a to supply a driving pulse φ1A, and the wiring 30a to supply a driving pulse φ2A, alternately. In a similar manner, the transfer electrodes 28b which are included in the block B and adjoining each other are connected, in pairs, to the wiring 29b to supply a driving pulse φ1B and the wiring 30b to supply a driving pulse φ2B.

Since each of the photoelectric conversion sections 16 and the electric charge detection section 23 are the same as those according to the first embodiment, description thereof will be omitted.

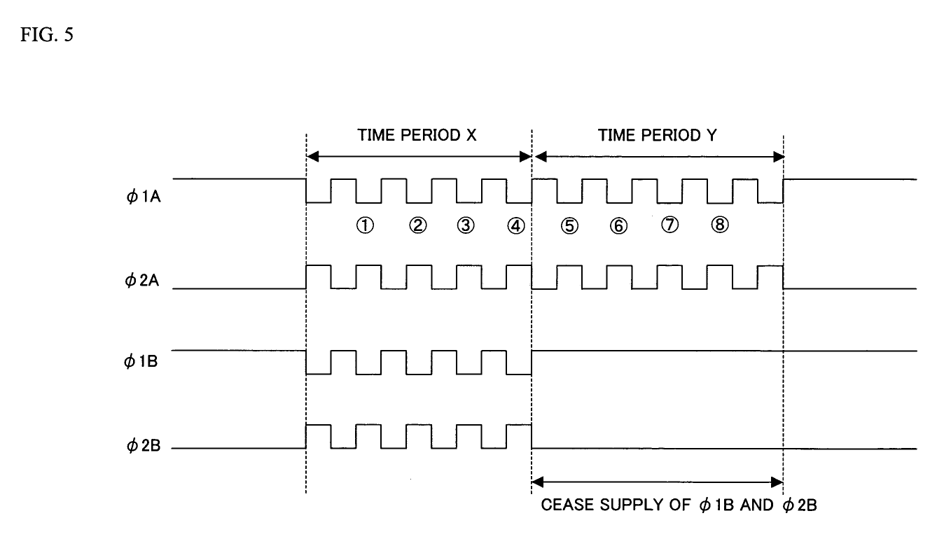

FIG. 5 is a timing chart showing a driving method of the solid-state imaging device shown in FIG. 4.

Based on an imaging instruction (not shown) inputted to an imaging system, electric charges corresponding to intensity of incident light are accumulated on the respective photoelectric conversion sections 16, and the accumulated electric charges are outputted to the electric charge transfer section 27.

During a time period X, as shown in FIG. 5, the driving pulses φ1A and φ2A are supplied to the transfer electrodes 28a in the block A via the wirings 29a and 30a, and the driving pulses φ1B and φ2B are supplied to the transfer electrodes 28b in the block B via the wirings 29b and 30b. The common driving pulses are supplied to each of the block A and the block B simultaneously, whereby each of the electric charges held in the electric charge transfer section 27 is transferred to the electric charge detection section 23 in sequence, in units of pixels.

As a result, at timings of circled numbers one to four shown in FIG. 5, each of the electric charges outputted from a first to a fourth photoelectric conversion sections 16 are sequentially outputted to the electric charge detection section 23.

During a time period Y, as shown in FIG. 5, the driving pulses φ1A and φ2A are continuously supplied to the block A, and the driving pulses φ1B and φ2B are stopped being supplied to the block B. The electric charges outputted from a fifth to an eighth photoelectric conversion sections 16 are already transferred to the block A during the time period X. Therefore, during the time period Y, only the block A is driven, whereby the electric charges outputted from the fifth to eighth photoelectric conversion sections 16 are outputted to the electric charge detection section 23, in sequence, at timings of the circled number five to eight shown in FIG. 5.

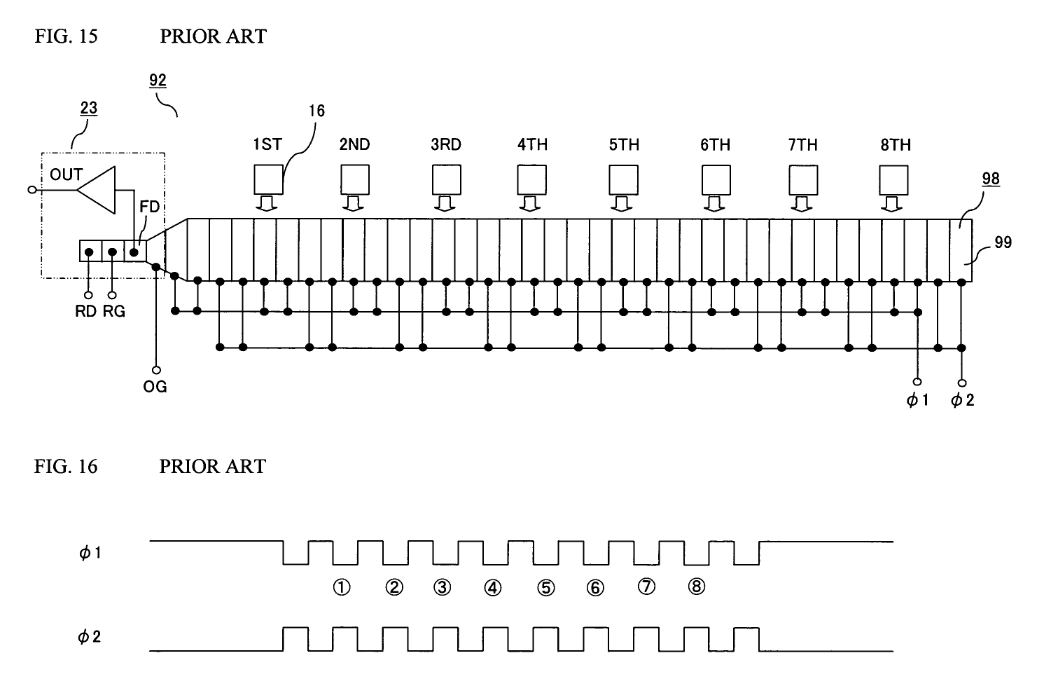

In this manner, in the case of the driving method of the solid-state imaging device according to the present embodiment, operation of the block B, which is a part of the horizontal transfer section 19, stops during the time period Y, and thus it is possible to reduce the power consumed in the horizontal transfer section 27 compared to the case of the conventional driving method shown in FIGS. 15 and 16. Specifically, as is the case of the present embodiment, in the case where the horizontal transfer section 27 is constituted of the block A and the block B whose lengths are equal to each other, it is possible to reduce the power consumption of the horizontal transfer section 27 by approximately 25%.

In the above-described example, the case is described where the horizontal transfer section 27 is drive-controlled in units of blocks which are constituted of two blocks, i.e., the block A and the block B, whose length are approximately equal to each other. However, the above-described driving method may be applicable to a case where the horizontal transfer section 27 is divided into three or more blocks whose lengths are approximately equal to one another, and then driven in units of blocks. In the same manner as the first embodiment, assuming that the horizontal transfer section 27 is divided into N blocks whose length are approximately equal to one another, and then driven in units of blocks, it is possible to reduce the power consumption of the horizontal transfer section 27 by {(N+1)/2N} times as much as that of the case where the horizontal transfer section 27 is not divided.

As described in the first and second embodiments, a basic concept of the driving method according to the present invention is as follows. That is, the horizontal transfer section or the electric charge transfer section are each divided into a plurality of blocks, a driving pulse is supplied to each of the blocks individually, and the driving pulse is sequentially stopped being supplied to those blocks which have completed transferring of the respective electric charges held therein. In the case where this type of the driving method is mounted in a solid-state imaging device, it is desirable that the electric charges are transferred smoothly among the adjoining blocks in order to improve transfer accuracy of the horizontal transfer section. Therefore, in a third to a fifth embodiments described below, a feature for further improving the transfer accuracy of the electric charges will be described based on the driving method according to the present invention.

### Third Embodiment

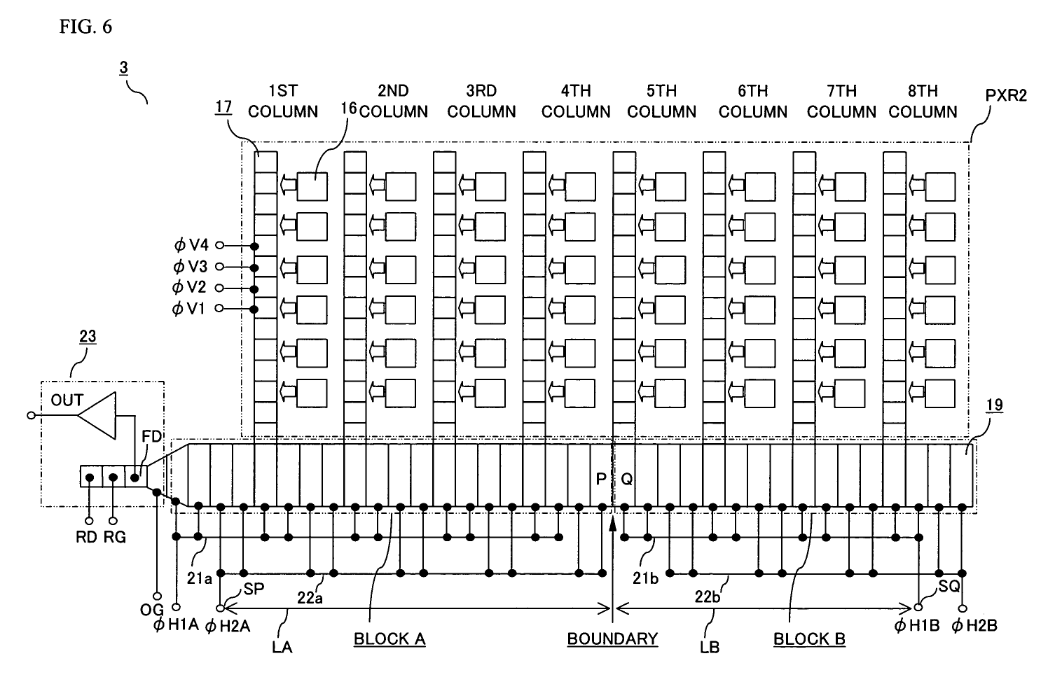

FIG. 6 is a diagram showing a general configuration of a solid-state imaging device according to a third embodiment of the present invention.

Since a basic configuration of a solid-state imaging device 3 according to the present embodiment is the same as that of the first embodiment, a difference between the present embodiment and the first embodiment will be mainly described, hereinafter.

The solid-state imaging device 3 shown in FIG. 6 has a feature in which a product between a resistance and a capacity of two respective parts of wirings each from a transfer electrode situated at a boundary between a pair of blocks to a driving pulse supply point is approximately equal to each other. Specifically, a part of the wiring 22a, from a transfer electrode P arranged at the boundary between the adjoining blocks A and B to a driving pulse supply point SP, and a part of the wiring 21b, from a transfer electrode Q arranged at the same boundary to a driving pulse supply point SQ, are each formed such that the product between the resistance and the capacity of each of the parts of the wirings 22a and 21b is approximately equal to each other.

The product between the resistance and the capacity of the part of the wiring from the driving pulse supply point to the transfer electrode at the boundary is not necessarily precisely equal between the block A and the block B, and may be different therebetween as long as the electric charges can be transferred from the block A to the block B appropriately. A degree of an acceptable difference in the product between the resistance and the capacity of each of the wirings may vary depending on a clock number of a driving pulse. As an example, in the case where a frequency of a horizontal driving pulse is approximately 40 MHz, it is preferable that the difference between two values (i.e., the product between the resistance and the capacity of the respective wirings), which are calculated for the respective parts of the wirings, is 20% or less, more preferably 10% or less, of a smaller one of the two values.

Further, the resistance and the capacity of the wiring can be adjusted by changing a width and a length of the wiring. As an exemplary case, in the present embodiment, a distance LA from the boundary between the adjoining blocks to the driving pulse supply point SP and a distance LB from the boundary between the adjoining blocks to the driving pulse supply point SQ are set approximately equal to each other, whereby the product between the resistance and the capacity of the respective parts of the wirings each from the pulse supply point to the electrode at the boundary can be adjusted so as to be equal to each other. The situation where the distance LA and the distance LB are approximately equal to each other represents that the product between the resistance and the capacity of the respective parts of the wirings is close to each other and not so different as to exceed the above-described degree of the acceptable difference.

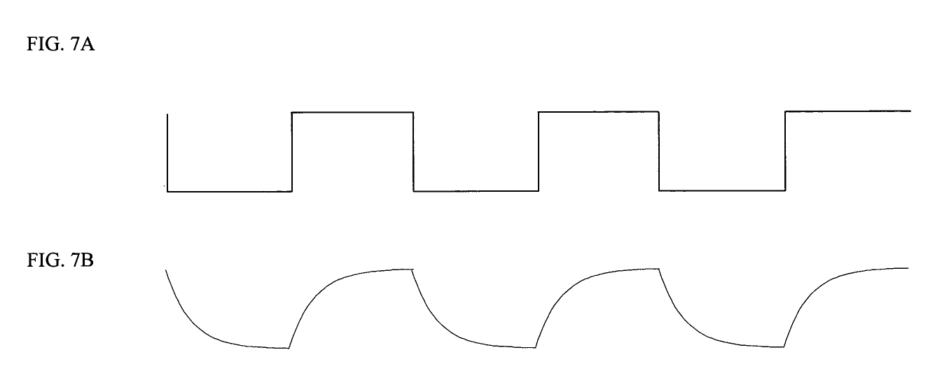

FIG. 7A is a diagram showing a waveform of a driving pulse at a driving pulse supply point, and FIG. 7B is a waveform of a driving pulse at a point away from the driving pulse supply point.

The waveform (FIG. 7A) of the driving pulse at each of the pulse supply points SP and SQ depends on a time constant represented by the product between the resistance and the capacity of each of the respective parts of the wirings, and the waveform varies as shown in FIG. 7B. In the case where a degree of attenuation of the pulse like this differs between the transfer electrode P and the transfer electrode Q each arranged right across the boundary between the blocks, a timing of a potential change for each of the transfer electrode P and the transfer electrode Q becomes out of synchronization, and thus a possibility may be considered that the electric charges will not transferred from the block B to the block A appropriately.

In the present embodiment, the product between the resistance and the capacity of the wiring from the transfer electrode P to the pulse supply point SP is approximately the same as the product between the resistance and the capacity of the wiring from the transfer electrode Q to the pulse supply point SQ, the degree of the attenuation of the driving pulse at each of the transfer electrode P and the transfer electrode Q are approximately identical to each other. As a result, transfer of the electric charges between the blocks can be performed smoothly in the same manner as the transfer of the electric charges within each of the blocks, whereby the electric charges are transferred by the horizontal transfer section 19 in a secured manner.

In the present embodiment, a position of each of the pulse supply points SP and the pulse supply point SQ provided on the wiring are adjusted with respect to the boundary between the block A and the block B, whereby the time constant is adjusted with respect to each of the respective parts of the wirings from the supply point SP to the transfer electrode P and from the supply point SQ to the transfer electrode Q. According to this adjusting method, it is possible to cause the attenuation of the driving pulse at respective positions in the vicinity of the boundary between the blocks to be identical to each other without changing a width and a length of each of the wirings 21a, 21b, 22a and 22b, or a design such as a size or the like of the area in which the wirings are formed.

### Fourth Embodiment

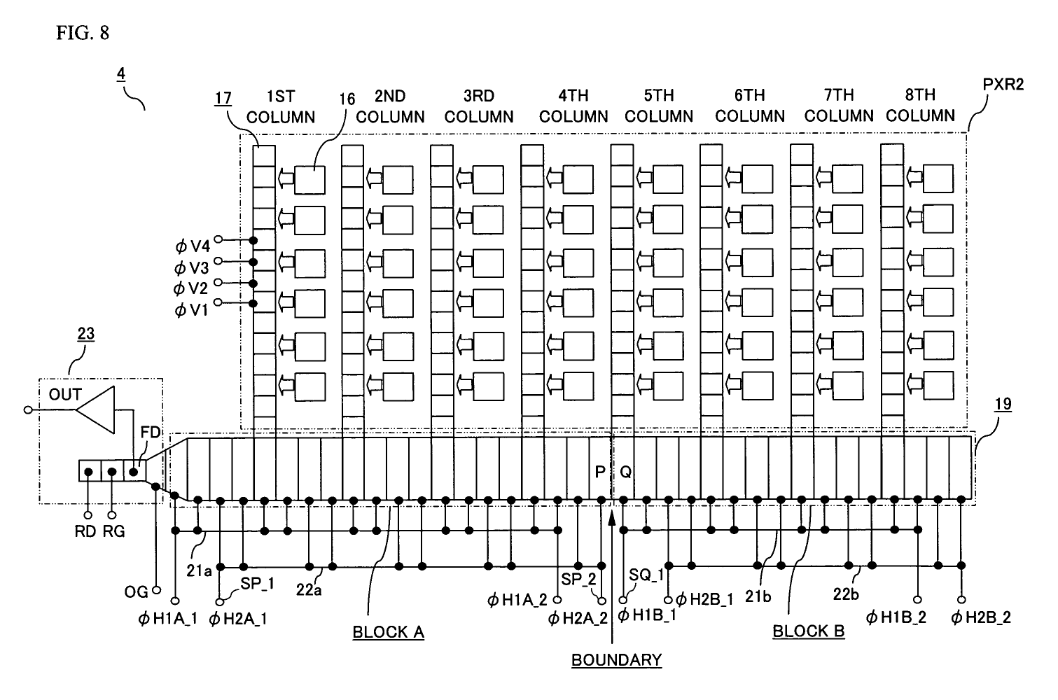

FIG. 8 is a diagram showing a general configuration of a solid-state imaging device according to a fourth embodiment of the present invention.

Since a basic configuration of a solid-state imaging device 4 according to the present embodiment is the same as that according to the third embodiment, different points between the present embodiment and the third embodiment will be mainly described hereinafter.

The solid-state imaging device 4 shown in FIG. 8 is different from that according to the third embodiment in that two driving pulse supply points are provided to each of the wirings connected to the horizontal transfer section 19. For example, two driving pulse supply points SP_1 and SP_2 are provided to the wiring 21a which is connected to the block A, and the common driving pulse φH1A (see FIG. 3) is supplied to both of the driving pulse supply points SP_1 and SP_2. In a similar manner, two driving pulse supply points are provided to each of the other wirings 21b, 22a and 22b.

In the present embodiment as well, a product between a resistance and a capacity of a part of the wiring from the transfer electrode P situated at the boundary between blocks to a driving pulse supply point H2A_2, and a product between a resistance and a capacity of a part of the wiring from the transfer electrode Q to a driving pulse supply point H1B_1 are adjusted so as to be approximately equal to each other.

In the case of the solid-state imaging device 4 according to the present embodiment as well, attenuation of the driving pulse at each of the transfer electrode P and the transfer electrode Q, which are respectively arranged at the boundary between the block A and the block B, are approximately identical to each other. Therefore, it is possible to transfer the electric charges between the blocks in the same manner as the transfer of electric charges within each of the blocks.

Further, in the present embodiment, two driving pulse supply points are provided to each of the wirings 21a, 21b, 22a and 22b, and thus the attenuation of the driving pulse at each of the transfer electrodes included in each of the blocks may be caused to be further identical to each other, compared to the above-described third embodiment.

In the present embodiment, although two driving pulse supply points (e.g., SP_1 and SP_2) are provided to one wiring (e.g., 21a), three or more driving pulse supply points may be provided to the one wiring.

### Fifth Embodiment

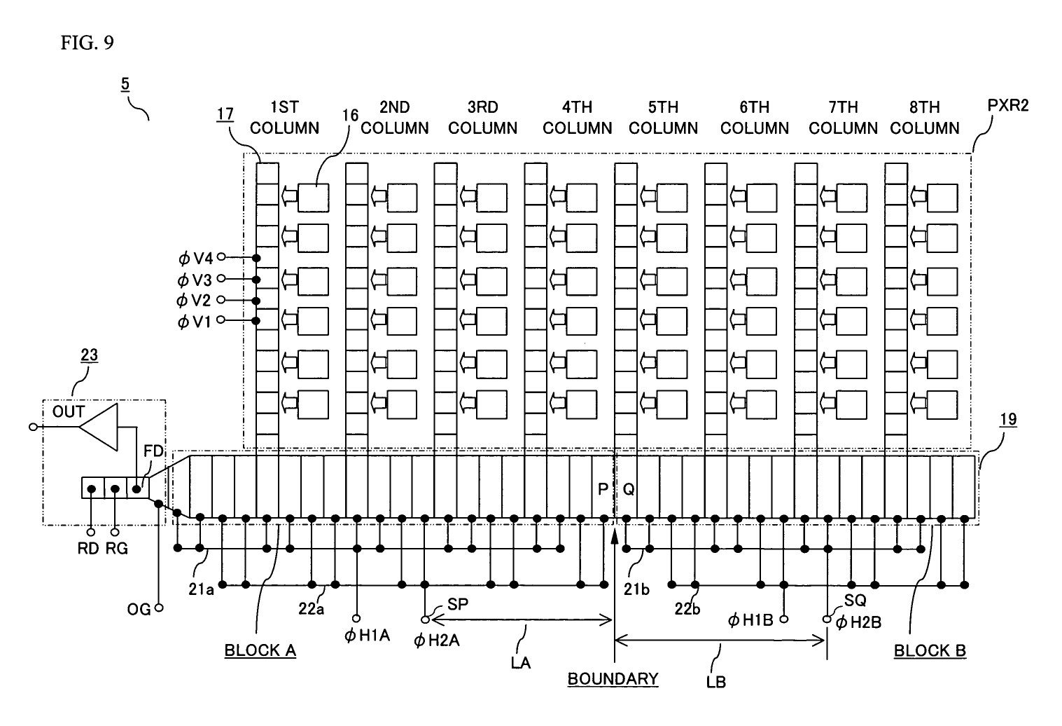

FIG. 9 is a diagram showing a general configuration of a solid-state imaging device according to a fifth embodiment of the present invention.

Since a basic configuration of the solid-state imaging device 5 according to the present embodiment is the same as that according to the third embodiment, different points between the present embodiment and the third embodiment will be mainly described hereinafter.

In the case of the solid-state imaging device 5 shown in FIG. 9, positions of driving pulse supply points provided to respective wirings are different from those of the solid-state imaging device according to the third embodiment. More specifically, the pulse supply point SP of the wiring 21a which is connected to the block A is provided at a position corresponding to approximately the center of the block A. A similar positioning is applied to the wirings 21b, 22a and 22b.

In the present embodiment, the driving pulse supply point SP and a driving pulse supply point SQ are arranged such that the distance LA from the boundary between the blocks to the driving pulse supply point SP and the distance LB from the boundary between the blocks to the driving pulse supply point SQ are approximately equal to each other. Based on this configuration, a product between a resistance and a capacity of apart of the wiring from the transfer electrode P situated at the boundary between the blocks to the driving pulse supply point SP, and a product between the resistance and the capacity of a part of the wiring from the transfer electrode Q to the driving pulse supply point SQ are adjusted so as to be approximately equal to each other.

In the case of the solid-state imaging device 5 according to the present embodiment as well, attenuation of each of the driving pulses at the transfer electrode P and the transfer electrode Q each situated at the boundary between the blocks A and B is approximately identical to each other. Therefore, it is possible to transfer the electric charges between the blocks in the same manner as the transfer of the electric charges within each of the blocks.

Further, in the present embodiment, since each of the driving pulse supply points is provided at the position corresponding to approximately the center of each of the blocks, a distance from each of the driving pulse supply points to each of the two respective transfer electrodes, which are each situated at a position most away from each of the corresponding driving pulse supply points, is approximately equal to each other. Therefore, in the solid-state imaging device 5 according to the present embodiment, it is possible to cause the attenuation of the driving pulse at each of the transfer electrodes included in the blocks to be further identical to each other, compared to the above-described third embodiment.

### Sixth Embodiment

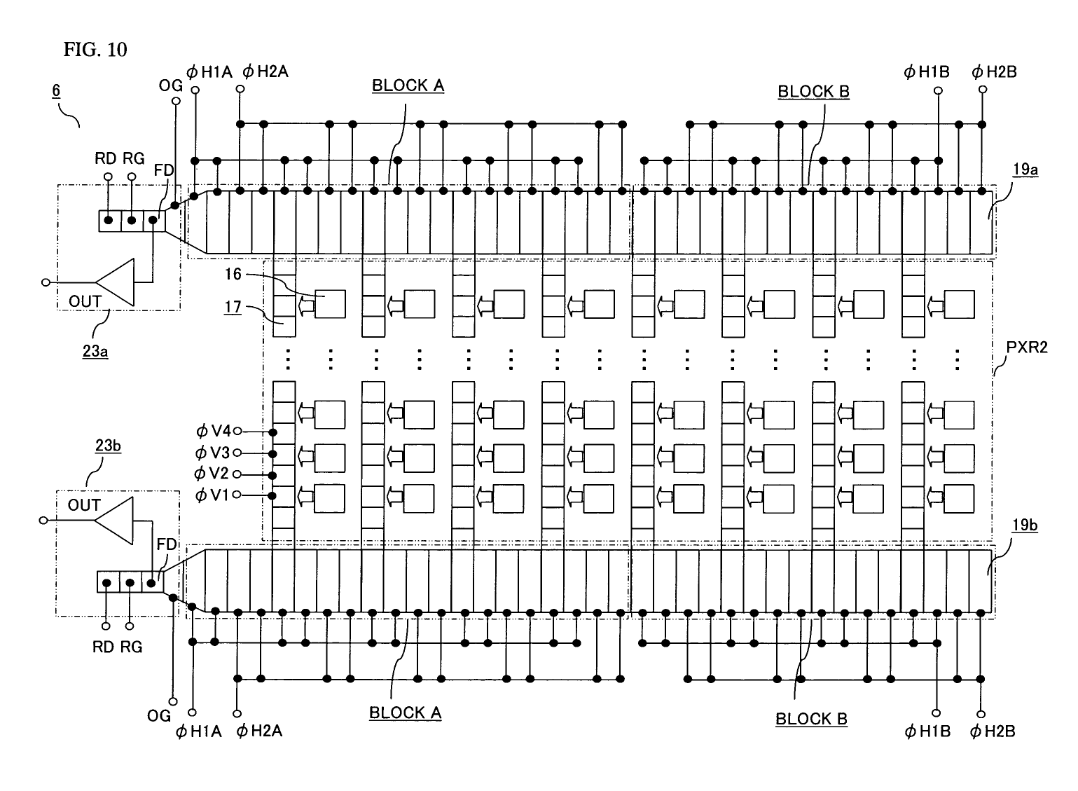

FIG. 10 is a diagram showing a general configuration of a solid-state imaging device according to a sixth embodiment of the present invention.

A solid-state imaging device 6 according to the present embodiment is different from the solid-state imaging device according to each of the above-described embodiments in that the solid-state imaging device 6 includes two horizontal transfer sections 19a and 19b and two electric charge detection sections 23a and 23b.

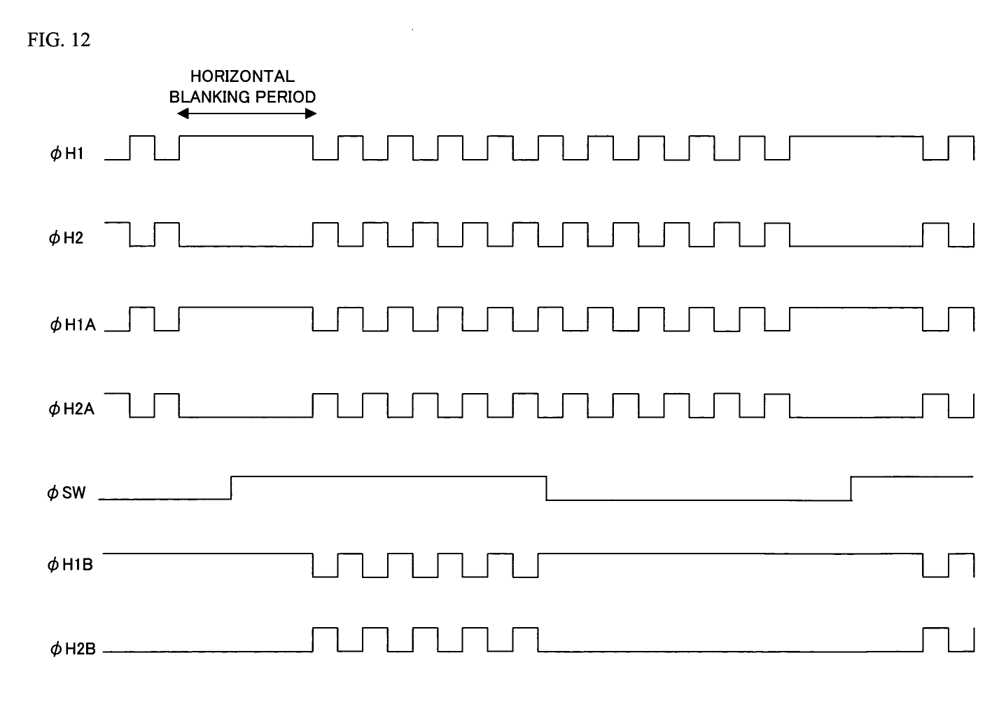

More specifically, the one horizontal transfer section 19a is electrically connected to one ends of respective vertical transfer sections 17, and outputs, to the electric charge detection section 23a, electric charges which are outputted from half of the rows (upper half rows shown in FIG. 12) of the photoelectric conversion sections 16. The other horizontal transfer section 19b is electrically connected to the other ends of the respective vertical transfer sections 17, and outputs, to the electric charge detection section 23b, electric charges which are outputted from the remaining half of the rows (lower half rows shown in FIG. 12) of the photoelectric conversion sections 16.

With respect to the horizontal transfer sections 19a and 19b, in the same manner as each of the above-described embodiments, when the electric charges in the block B in each of the horizontal transfer sections 19a and 19b are completely transferred to the block A, the driving pulses φH1B and φH2B are stopped being supplied to the block B.

Accordingly, inn the case of the solid-state imaging device 6 according to the present embodiment as well, it is possible to reduce a power consumption of each of the horizontal transfer sections 19a and 19b, in the same manner as each of the above-described embodiments. Specifically, as is the present embodiment, the solid-state imaging device 6 including the two horizontal transfer section 19a and 19b is capable of outputting electric charges of two rows concurrently, whereby it is possible to further improve a speed for reading an image.

In the present embodiment, although the two horizontal transfer sections 19a and 19b are each provided for half of the rows in a pixel area PXR 2, the number of the horizontal transfer sections may be three or more. For example, the pixel area PXR 2 may be divided into four sections, in a row direction and in a column direction, and four horizontal transfer sections may be provided to the divided four sections, respectively. In this case, each of the horizontal transfer sections is configured so as to include a plurality of blocks, and the driving method according to the present invention may be applied to this configuration.

### Seventh Embodiment

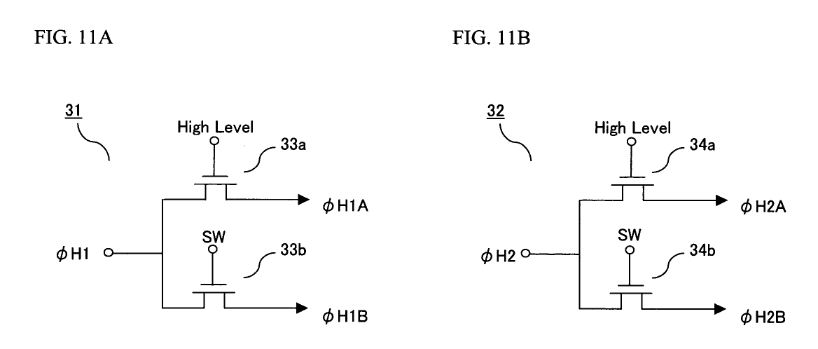

FIGS. 11A and 11B are diagrams each showing an exemplary switch circuit used for a solid-state imaging device according to a seventh embodiment of the present invention.

The solid-state imaging device according to the present embodiment includes a switch circuit which controls supply of a driving pulse to each of the blocks in the horizontal transfer section 19 and in the electric charge transfer section 27, in addition to component parts included in the solid-state imaging device according to each of the above-described embodiments.

The switch circuit 31 shown in FIG. 11A includes transistors 33a and 33b whose sources are commonly connected. The Sources of the transistors 33a and 33b are each connected to a supply point of the driving pulse φH1, and respective drains of the transistors 33a and 33b are respectively connected to pulse supply points H1A and H1B (e.g., the wirings 21a and 21b in FIG. 1). Further, a predetermined voltage (a High level voltage in the case of an example in the drawing) is applied to a gate of the transistor 33a such that the transistor 33a turns ON, and a switch pulse φSW is supplied to a gate of the transistor 33b from a control circuit such as a driving circuit (FIG. 1).

A switch circuit 32 shown in FIG. 11B also includes a transistor 34a having a predetermined voltage applied to a gate thereof, and a transistor 34b having a switch pulse φSW supplied to a gate thereof. Respective sources of the transistors 34a and 34b are each connected to a supply point of a driving pulse φH2, and respective drains of the transistors 34a and 34b are connected to pulse supply points H2A and H2B, respectively.

FIG. 12 is a diagram showing a driving method of the solid-state imaging device according to the seventh embodiment of the present invention.

As shown in FIG. 12, the switch pulse φSW is controlled such that the transistors 33b and 34b are ON (at the High level in an example of the drawing) during the time period X, whereas the transistors 33b and 34b are OFF during the time period Y in which no electric charge exists in the block B.

Therefore, during the time period X, the driving pulses φH1A, φH2A, φH1B and φH2B, which are substantially identical to the driving pulses φH1 and φH2 are supplied to both of the block A and the block B. Thereafter, during the time period Y, the transistors 33b and 34b are turned OFF, whereby supply of the driving pulses φH1B and φH2B to the block B is stopped.

To control the supply and a cessation of the supply of the driving pulses by using each of the switch circuits 31 and 32 according to the present embodiment is advantageous in that an increase in the number of input pins can be suppressed.

More specifically, in the case where the horizontal transfer section 19 is driven in two-phase by dividing the horizontal transfer section 19 into two blocks A and B, at least four pins (driving pulse supply points) are required to supply the driving pulses (φH1A, φH2A, φH1B and φH2B). Further, in the case where the horizontal transfer section 19 is driven in two-phase without diving the horizontal transfer section 19 into blocks, in the same manner as the conventional driving method (FIGS. 13 and 14), two pins are required to supply the driving pulses (φH1 and (φH2).

On the other hand, in the case where division of a pulse is controlled by the switch circuits 31 and 32 according to the present embodiment, the number of pins necessary to be increased is only one so as to supply the switch pulse (φSW, in addition to two pins which are essentially necessary to supply to the same driving pulses (φH1 and φH2) as the conventional driving method. In this manner, the increase in the number of the pins can be suppressed compared to the conventional solid-state imaging device.

The configuration and the driving method of the solid-state imaging device according to the present invention may be applicable to a solid-state imaging device in which electric charges outputted from respective pixels (photoelectric conversion section) are added within a vertical transfer section or within a horizontal transfer section (electric charge transfer section) in order to improve a frame rate and sensitivity. In this case, a method for adding the electric charges is not specifically limited. The present invention may be applicable to a solid-state imaging device having any one method of two-pixel addition, four-pixel addition, and nine-pixel addition, for example.

In each of the above-described embodiments, although the example of the horizontal transfer section or the electric charge transfer section which is divided into two blocks is described, the number of the blocks may be three or more.

The present invention may be used as a solid-state imaging device embedded in an imaging device such as a digital camera, an image scanner, copy machine and the like and a driving method thereof.

While the invention has been described in detail, the foregoing description is in all aspects illustrative and not restrictive. It is understood that numerous other modifications and variations can be devised without departing from the scope of the invention.

What is claimed is:

1. A driving method of a solid-state imaging device including a plurality of photoelectric conversion sections which are arranged two-dimensionally, a plurality of vertical transfer sections provided for respective columns of the plurality of photoelectric conversion sections, a horizontal transfer section including a plurality of blocks each individually receiving supply of a driving pulse, and an electric charge detection section for detecting electric charges, the driving method comprising:
outputting the electric charges accumulated in each of the plurality of photoelectric conversion sections to each of the plurality of vertical transfer sections;
transferring the electric charges held in said each of the plurality of vertical transfer sections to the horizontal transfer section in sequence;
transferring the electric charges held in the horizontal transfer section to the electric charge detection section by supplying the driving pulse individually to each of the plurality of blocks; and
stopping supply of the driving pulse to a block, among the plurality of blocks, having no electric charge.

2. The driving method of the solid-state imaging device according to claim 1, wherein:
the solid-state imaging device further includes a switch transistor electrically connected to said each of the plurality of blocks; and
the supply of the driving pulse and a cessation of the supply of the driving pulse are performed by switching on and off the switch transistor.

3. A driving method of a solid-state imaging device including a plurality of photoelectric conversion sections arranged one-dimensionally, a horizontal transfer section including a plurality of blocks each individually receiving supply of a driving pulse, and an electric charge detection section for detecting electric charges, the driving method comprising:
outputting the electric charges accumulated in each of the plurality of photoelectric conversion sections to the electric charge transfer section;
transferring the electric charges held in the electric charge transfer section to the electric charge detection section, in sequence, by supplying the driving pulse individually to each of the plurality of blocks; and
stopping supply of the driving pulse to a block, among the plurality of blocks, having no electric charge.

4. The driving method of the solid-state imaging device according to claim 3, wherein:
the solid-state imaging device further includes a switch transistor electrically connected to said each of the plurality of blocks; and
the supply of the driving pulse and a cessation of the supply of the driving pulse are performed by switching on and off the switch transistor.

5. A solid-state imaging device, comprising:
a plurality of photoelectric conversion sections arranged two-dimensionally;
vertical transfer sections which are provided for respective columns of the plurality of photoelectric conversion sections and transfer, in sequence, electric charges outputted by the plurality of the photoelectric conversion sections in a vertical direction;
a horizontal transfer section which includes N blocks (N is a natural number of 2 or more) each having a plurality of transfer electrodes and transfers, in sequence, the electric charges outputted by each of the vertical transfer sections in a horizontal direction;
a plurality of wirings which are provided for said each of the N blocks and connected to a driving pulse supply point for supplying a driving pulse and to each of the plurality of transfer electrodes included in said each of the N blocks; and
an electric charge detection section for detecting the electric charges outputted by the horizontal transfer section, wherein
a product between a resistance and a capacity of a part of each of the plurality of wirings is approximately equal between the plurality of wirings, the part of each of the plurality of wirings being from one of a pair of the plurality of transfer electrodes, which are situated across a boundary between two adjoining blocks of the N blocks, to a driving pulse supply point connected to said one of the pair of the plurality of transfer electrodes.

6. The solid-state imaging device according to claim 5, wherein a distance from the boundary between the two adjoining blocks to the driving pulse supply point is approximately identical between the adjoining two blocks.

7. The solid-state imaging device according to claim 5, further comprising a switch transistor connected to the driving pulse supply point.

8. The solid-state imaging device according to claim 5, wherein a length of each of the N blocks is approximately equal to each other.

9. A solid-state imaging device, comprising:
a plurality of photoelectric conversion sections arranged one-dimensionally;
an electric charge transfer section which includes N blocks (N is a natural number of 2 or more) each having a plurality of transfer electrodes and transfers, in sequence, electric charges outputted by each of the plurality of photoelectric conversion sections;
a plurality of wirings which are provided for each of the N blocks and connected to a driving pulse supply point for supplying a driving pulse and to each of the plurality of transfer electrodes included in each of the N blocks; and
an electric charge detection section for detecting the electric charges outputted by the horizontal transfer section, wherein
a product between a resistance and a capacity of a part of each of the plurality of wirings is approximately equal between the plurality of wirings, the part of each of the plurality of wirings being from one of a pair of the plurality of transfer electrodes, which are situated across a boundary between two adjoining blocks of the N blocks, to a driving pulse supply point connected to said one of the pair of the plurality of transfer electrodes.

10. The solid-state imaging device according to claim 9, wherein a distance from the boundary between the two adjoining blocks to the driving pulse supply point is approximately identical between the adjoining two blocks.

11. The solid-state imaging device according to claim 9, further comprising a switch transistor connected to the driving pulse supply point.

12. The solid-state imaging device according to claim 9, wherein a length of each of the N blocks is approximately equal to each other.
